(19) United States
(12) Patent Application Publication
(10) Pub. No.: US 2014/0085402 A1
(43) Pub. Date: Mar. 27, 2014

(54) CONFERENCE TERMINAL AND METHOD FOR PROCESSING VIDEOS FROM OTHER CONFERENCE TERMINALS

(71) Applicant: HON HAI PRECISION INDUSTRY CO., LTD., New Taipei (TW)

(72) Inventors: HON-DA WANG, New Taipei (TW); TENG-SHUO CHANG, New Taipei (TW); CHUN-CHI LEE, New Taipei (TW)

(73) Assignee: HON HAI PRECISION INDUSTRY CO., LTD., New Taipei (TW)

(21) Appl. No.: 13/971,862

(22) Filed: Aug. 21, 2013

(30) Foreign Application Priority Data
Sep. 21, 2012 (TW) 101134851

(51) Int. Cl. H04N 7/15

(52) U.S. Cl. CPC H04N 7/15
USPC 348/14.07

(57) ABSTRACT

A method executed by a conference terminal for processing videos from other conference terminals includes the following steps. Capture a video in front of the video camera. Extracting sub-images of the projection screen and the indicator from each video frame. Determining a size of the sub-image of the projection screen and size of the sub-image of the indicator. Determining distances between one fixed spot of the indicator and two reference spots of the projection screen in each video frame. Receiving from each other conference terminal the sub-image of the indicator, the sizes of the sub-images of the indicator and the projection screen, and the distances. Scaling the sub-image of each indicator from each of the other conference terminals and the distances from each other conference terminals. And positioning each scaled sub-image of the indicator to the projection screen according to the scaled distances to obtain a combined image.

### BACKGROUND

1. Technical Field

The present disclosure relates to conference terminals, and more specifically, to a conference terminal and a method for processing videos from other conference terminals.

2. Description of Related Art

Conference systems are widely used to share electronic conferences by transmitting and receiving videos among a variety of conference terminals placed at different meeting rooms. In a conventional conference system as shown in FIG. 5, presenters in different meeting rooms present a same presentation file using their fingers. A display of each conference terminal is divided into several regions to display the presentation file and the presenters in other meeting rooms, such as presenter A and presenter B for example. Therefore, attendees in a meeting room can see the presenters in other meeting rooms, but can not quickly find out which part of the presentation file is currently interpreted by each presenter.

Therefore, there is a need to provide a means to overcome the above-described shortcomings.

### BRIEF DESCRIPTION OF THE DRAWINGS

Many aspects of the present disclosure should be better understood with reference to the following drawings. The emphasis is placed upon clearly illustrating the principles of the present disclosure.

FIG. 1 is a block diagram of conference system, in accordance with an exemplary embodiment.

FIG. 2 is a block diagram of one of conference terminals of the conference system of FIG. 1, in accordance with an exemplary embodiment.

FIG. 3 is a schematic view showing that images of different presenters are simultaneously displayed in a display of one conference terminal of FIG. 2s.

FIG. 4 is a flowchart of a method for processing videos from other conference terminals, in accordance with an exemplary embodiment.

FIG. 5 is schematic view of a known conference terminal showing that images of different presenters are simultaneously displayed in a display of the conference terminal, which is different from FIG. 3.

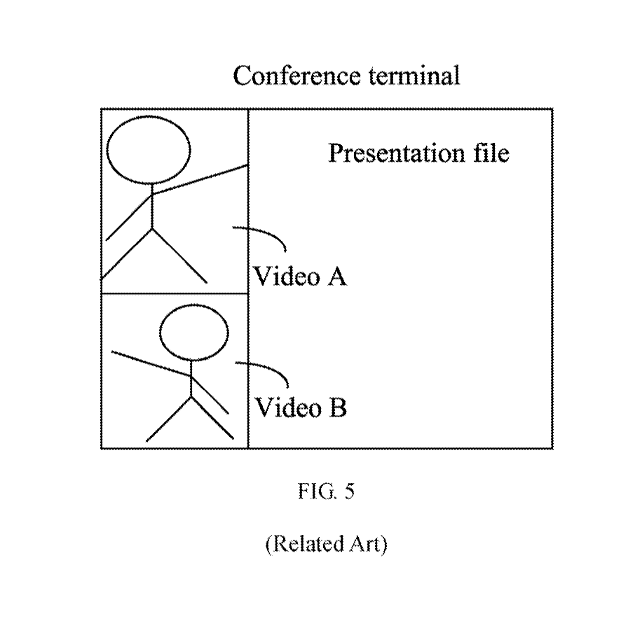

### DETAILED DESCRIPTION

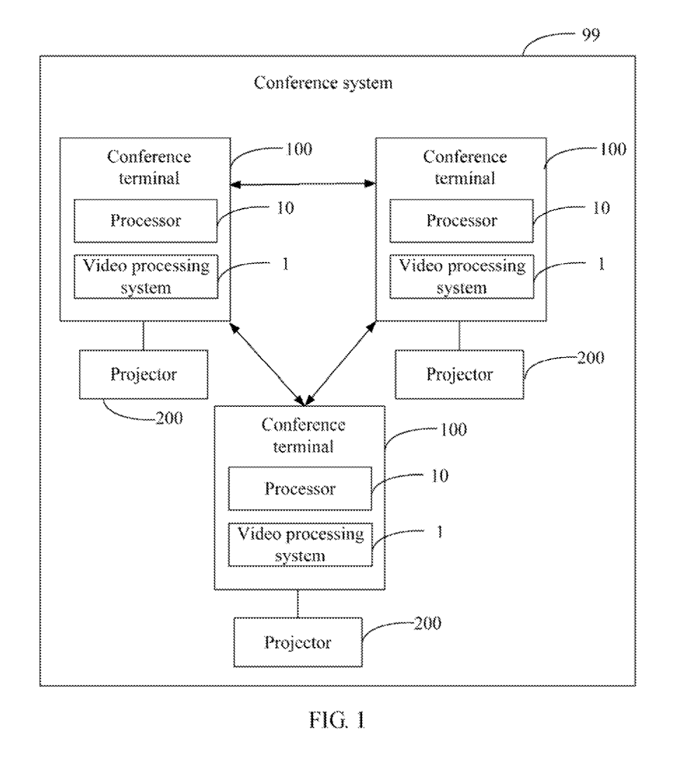

FIG. 1 illustrates an embodiment of a conference system 99. The conference system 99 includes two or more conference terminals 100 connected to each other via a network (e.g. Internet) and can communicate with each other. The conference terminals 100 may be laptop computers or tablet computers. FIG. 1 shows three conference terminals 100 for simplicity. However, the number of the conference terminals 100 can be varied. Each conference terminal 100 is connected to a projector 200 and a video camera (not shown). The projector 200 projects different pages of a presentation file played by the conference terminal 100 on a projection screen (not shown). The video camera is arranged on a position to capture a video in front of the projection screen. The captured video includes a variety of video frames each including the projection screen displaying the currently presented content of the presentation file and an indicator. In the embodiment, a presenter presents the presentation file using his or her finger, thus the indicator may at least include a part of the finger of the presenter. In an alternative embodiment, the presenter interprets the presentation file projected on the projection screen using a laser pointer, thus the captured indicator is a bright spot in the projection screen.

Each conference terminal 100 includes a processor 10 and a video processing system 1 which includes a variety of modules executed by the processor 10 to perform functions of the conference terminal 100.

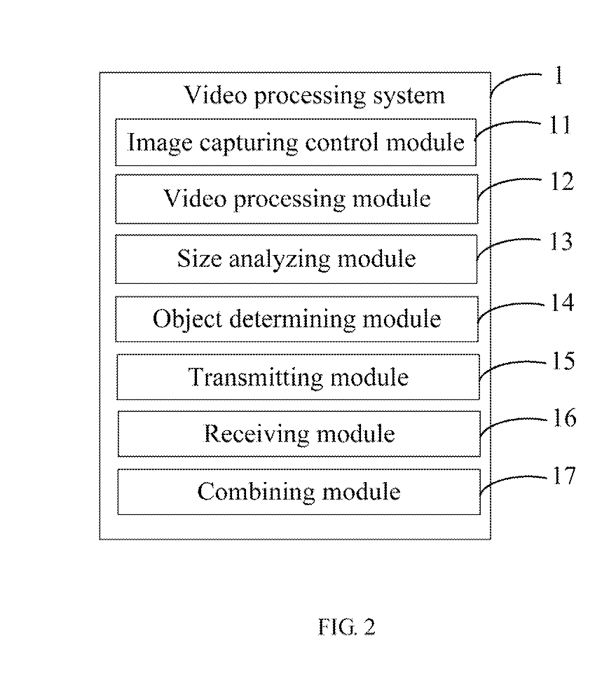

FIG. 2 shows that the video processing system 1 includes an image capturing control module 11, a video processing module 12, a size analyzing module 13, an object determining module 14, a transmitting module 15, a receiving module 16, and a combining module 17.

The image capturing control module 11 directs the video camera to capture a video in front of the video camera.

The video processing module 12 receives video frames of the captured video in sequence, and extracts sub-images of the projection screen and the indicator from each video frame of the captured video. In the embodiment, the sub-images of the projection screen and the indicator have different brightness. The video processing module 12 extracts the sub-images of the projection screen and the indicator from each video frame according the brightness difference. Such an extraction method is known in the art, such as the subject matter of CN Patent Application Publication No. 201210535522.2, which is herein incorporated by reference.

The size analyzing module 13 determines a size of the sub-image of the projection screen and a size of the sub-image of the indicator when the sub-images of the projection screen and the indicator are extracted from one video frame. In the embodiment, the size analyzing module 13 determines the height of the sub-image of the projection screen as the its size, and determines the height of the sub-image of the indicator as the its size.

The object determining module 14 determines distances respectively between one fixed spot of the indicator and at least two reference spots of the projection screen in each video frame. Specifically, the object determining module 14 selects the center of the sub-image of the indicator as the fixed spot, and selects the left upper edge and the right lower edge of the sub-image of projection screen as the two reference spots.

The transmitting module 15 transmits the sub-image of the indicator, the size of the sub-image of the indicator, the size of the sub-image of the projection screen, and the distances respectively between the fixed spot of the indicator and the reference spots of the projection screen to other conference terminal 100 when one video frame of the received video is processed.

The receiving module 16 receives the sub-images of the indicators, the size of the sub-images of the indicators, the size of the sub-images of the projection screen, and the distances respectively between the fixed spot of the indicator and the reference spots of the projection screen from each of the other conference terminals 100.

The combining module 17 computes a ratio of the size of the sub-image of the projection screen determined by the video processing module 12 to the size of the sub-image of the projection screen received from each of the other conference terminals 100, and scales the sub-image of each indicator received from each of the other conference terminals 100 and the distances between the fixed spot of each indicator and the reference spots of the projection screen received from each of the other conference terminals 100 according to the ratio. The combining module 17 further positions each scaled sub-image of the indicator to the projection screen according to the scaled distances to obtain a combined image. That is, the sub-images of the indicators from other conference terminals 100 can be rightly positioned to indicate which part of the presentation file is currently indicated by the indicator, thereby attendees can easily find out which part of the presentation file is currently presented by the presenter.

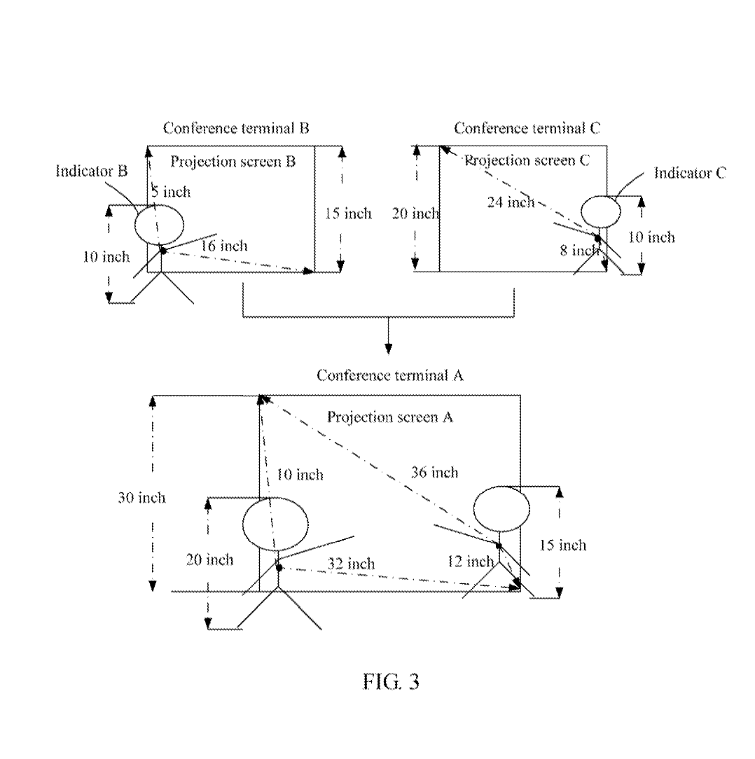

FIG. 3 shows three conference terminals 100A, 100B and 100C at different meeting rooms. The conference terminal 100A receives one sub-image of the indicator from the conference terminal 100B (hereinafter indicator B), and one sub-image of the indicator from the conference terminal 100C (hereinafter indicator C). The size of the sub-image of the projection screen of the conference terminal 100B (hereinafter projection screen B) is 15 inch, the size of the sub-image of the indicator B is 10 inch, the distances between the center of the sub-image of the indicator B and two reference spots of the sub-image of the projection screen B are respectively 5 inch and 16 inch. The size of sub-image of the projection screen of the conference terminal 100C (hereinafter projection screen C) is 20 inch, the size of the sub-image of the indicator C is 10 inch, the distances between the center of the sub-image of the captured indicator C and two reference spots of the sub-image of the projection screen C are respectively 8 inch and 24 inch. The size of the sub-image of projection screen corresponding to the conference terminal 100A (hereinafter projection screen A) is 30 inch, which is twice of the projection screen B and 1.5 times of the projection screen C. Thus, the size of the sub-image of the indicator B is scaled to 20 inch (2×10 inch), the size of the sub-image of the indicator C is scaled to 15 inch (1.5×10 inch), the distances between the center of the sub-image of the indicator B and two reference spots of the sub-image of the projection screen B are scaled to 10 inch (2×5 inch) and 32 inch (2×16 inch), and the distances between the center of the sub-image of the indicator C and two reference spots of the sub-image of the projection screen C are scaled to 12 inch (1.5×8 inch) and 36 inch (1.5×24 inch). Then, the scaled indicators B, C are positioned to the projection screen A according to the scaled distances to obtain a combined image.

In an alternative embodiment, when the video processing module 12 identifies no sub-image of the indicator from one video frame from one conference terminal 100, the conference terminal 100 then stops transmitting the sub-image of the indicator to other conference terminals 100. In this case, other conference terminal 100 will not display the video from this conference terminal 100.

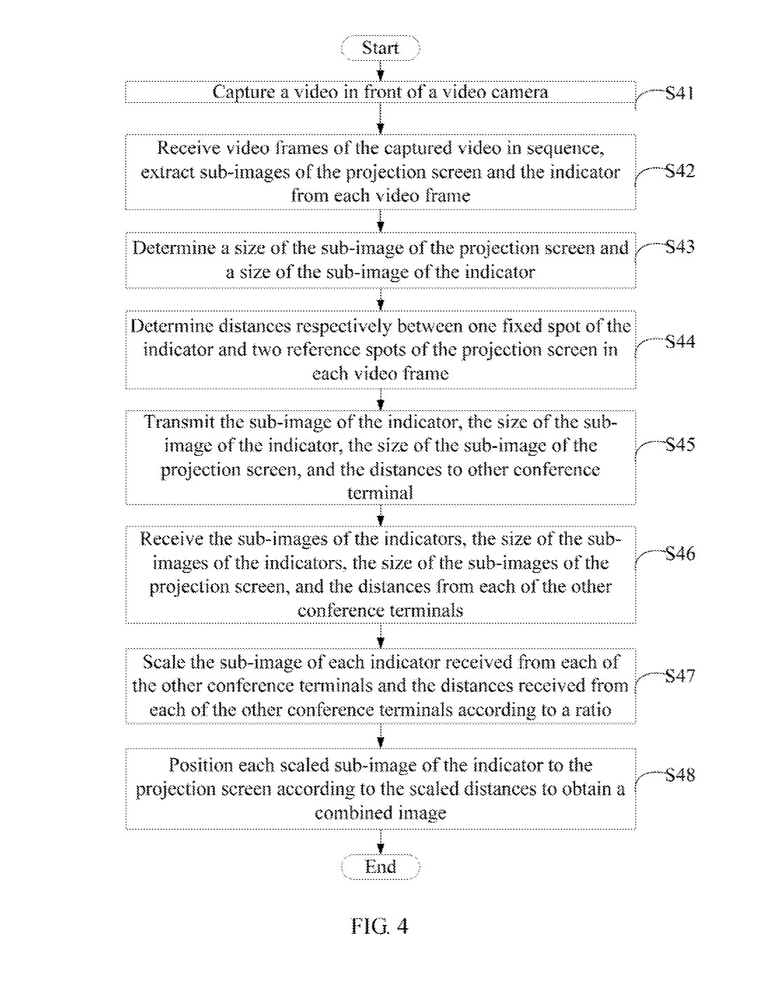

FIG. 4 is a flowchart of a method for processing videos from other conference terminal 100, in accordance with an exemplary embodiment.

In step S51, the image capturing control module 11 directs the video camera to capture a video in front of the video camera.

In step S52, the video processing module 12 receives video frames of the captured video in sequence, and extracts sub-images of the projection screen and the indicator from each video frame of the captured video.

In step S53, the size analyzing module 13 determines a first size of the sub-image of the projection screen and a second size of the sub-image of the indicator when the sub-images of the projection screen and the indicator are extracted from one video frame.

In step S54, the object determining module 14 determines distances respectively between one fixed spot of the indicator and at least two reference spots of the projection screen in each video frame.

In step S55, the transmitting module 15 transmits the sub-image of the indicator, the size of the sub-image of the indicator, the size of the sub-image of the projection screen, and the distances between the fixed spot of the indicator and the reference spots of the projection screen to other conference terminal 100 when one video frame of the received video is processed.

In step S56, the receiving module 16 receives the sub-images of the indicators, the size of the sub-images of the indicators, the size of the sub-images of the projection screen, and the distances respectively between the fixed spot of the indicator and the reference spots of the projection screen from each of the other conference terminals 100.

In step S57, the combining module 17 computes a ratio of the size of the sub-image of the projection screen determined by the video processing module 12 to the size of the sub-image of the projection screen received from each of the other conference terminals 100, and scales the sub-image of each indicator received from each of the other conference terminals 100 and the distances between the fixed spot of each indicator and the reference spots of the projection screen received from each of the other conference terminals 100 according to the ratio.

In step S58, the combining module 17 positions each scaled sub-image of the indicator to the projection screen according to the scaled distances to obtain a combined image.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments.

What is claimed is:

1. A conference terminal capable of processing videos from other conference terminals, each conference terminal connected to a projector which projects a presentation file played by the connected conference terminal on a projection screen, the conference terminal comprising:
a processor to execute a plurality of modules, wherein the plurality of modules comprises:
an image capturing control module to direct a video camera to capture a video in front of the video camera, and the captured video comprising a plurality of video frames each comprising a projection screen displaying currently presented content of the presentation file and an indicator;
a video processing module to receive video frames of the captured video in sequence, and extract sub-images of the projection screen and the indicator from each video frame of the captured video;
a size analyzing module to determine a size of the sub-image of the projection screen and a size of the sub-image of the indicator when the sub-images of the projection screen and the indicator are extracted from one video frame;
an object determining module to determine distances respectively between one fixed spot of the indicator and at least two reference spots of the projection screen in each video frame;
a transmitting module to transmit the sub-image of the indicator, the size of the sub-image of the indicator, the size of the sub-image of the projection screen, and the distances respectively between the fixed spot of the indicator and the reference spots of the projection screen to other conference terminal;
a receiving module to receive the sub-images of the indicators, the size of the sub-images of the indicators, the size of the sub-images of the projection screen, and the distance respectively between the fixed spot of the indicator and the reference spots of the projection screen from each of the other conference terminals; and
a combining module to compute a ratio of the size of the sub-image of the projection screen determined by the video processing module to the size of the sub-image of the projection screen received from each of the other conference terminals, scale the sub-image of each indicator received from each of the other conference terminals and the distances between the fixed spot of each indicator and the reference spots of the projection screen received from each of the other conference terminals according to the ratio, and position each scaled sub-image of the indicator to the projection screen according to the scaled distances to obtain a combined image.

2. The conference terminal of claim 1, wherein the sub-images of the projection screen and the indicator have different brightness, and the video processing module is configured to extract the sub-images of the projection screen and the indicator from each video frame according the brightness difference.

3. The conference terminal of claim 1, wherein the size analyzing module is configured to determine a height of the sub-images of the projection screen as its size, and determine a height of the sub-images of the indicator as its size.

4. The conference terminal of claim 1, wherein the object determining module is configured to determine a center of the sub-image of the indicator as the fixed spot, and select a left upper edge and a right lower edge of the sub-images of the projection screen as two reference spots.

5. The conference terminal of claim 1, wherein the transmitting module is configured to transmit the sub-image of the indicator, the size of the sub-image of the indicator, the size of the sub-image of the projection screen, and the distances respectively between the fixed spot of the indicator and the reference spots of the projection screen to other conference terminal when one video frame of the received video is processed.

6. A method executed by a conference terminal for processing videos from other conference terminals, the conference terminal connected to a projector which projects a presentation file played by the connected conference terminal on a projection screen, the method comprising:
directing a video camera to capture a video in front of the video camera, and the captured video comprising a plurality of video frames each comprising a projection screen displaying currently presented content of the presentation file and an indicator;
receiving video frames of the captured video in sequence;
extracting sub-images of the projection screen and the indicator from each video frame of the captured video;
determining a size of the sub-image of the projection screen and a size of the sub-image of the indicator when the sub-images of the projection screen and the indicator are extracted from one video frame;
determining distances respectively between one fixed spot of the indicator and at least two reference spots of the projection screen in each video frame;
transmitting the sub-image of the indicator, the size of the sub-image of the indicator, the size of the sub-image of the projection screen, and the distance respectively between the fixed spot of the indicator and the reference spots of the projection screen to other conference terminal, and receiving the sub-images of the indicators, the size of the sub-images of the indicators, the size of the sub-images of the projection screen, and the distance respectively between the fixed spot of the indicator and the reference spots of the projection screen from each of the other conference terminals;
computing a ratio of the determined size of the sub-image of the projection screen to the size of the sub-image of the projection screen received from each of the other conference terminals;
scaling the sub-image of each indicator received from each of the other conference terminals and the distances between the fixed spot of each indicator and the reference spots of the projection screen received from each of the other conference terminals according to the ratio; and
positioning each scaled sub-image of the indicator to the projection screen according to the scaled distances to obtain a combined image.

7. The method of claim 6, wherein the sub-images of the projection screen and the indicator have different brightness, and the sub-images of the projection screen and the indicator are extracted from each video frame according the brightness difference.

8. The method of claim 6, wherein the size of the sub-image of the projection screen is a height of the sub-image of the projection screen, and the size of the sub-image of the indicator is a height of the sub-image of the indicator.

9. The method of claim 6, wherein the fixed spot is a center of the sub-image of the indicator, and two reference spots are a left upper edge and a right lower edge of the sub-image of the projection screen.

10. The method of claim 6, wherein the sub-image of the indicator, the size of the sub-image of the indicator, the size of the sub-image of the projection screen, and the distances respectively between the fixed spot of the indicator and the reference spots of the projection screen are transmitted to other conference terminal when one video frame of the received video is processed.
